(19) United States
(12) Patent Application Publication
(10) Pub. No.: US 2003/0011343 A1
(43) Pub. Date: Jan. 16, 2003

(54) Solar reloader for batteries

(76) Inventor: Max Hobelsberger, Wuerenlingen (CH)

Correspondence Address: Max Hobelsberger, Dorfstr. 16, Wuerenlingen, 5303, CH

(21) Appl. No.: 10/173,767

(22) Filed: Jun. 19, 2002

Related U.S. Application Data
(60) Provisional application No. 60/300,819, filed on Jun. 27, 2001.

(51) Int. Cl. H02J 7/00

(52) U.S. Cl. 320/101

(57) ABSTRACT

The reloadable battery is equipped with solar cells on its casing. To reload the batteries one has to expose them just to daylight.

This is a continuation of the provisional application No. US60/300,819, filed No. 60/300,819.

### BACKGROUND OF THE INVENTION

1. Field of the Invention

This invention relates to batteries. More particularly, the invention relates to solar battery reloaders. One special embodiment is a battery with ingrated solar cell.

### PRIOR ART

Devices to reload batteries are well known. However these devices must usualy be connected to the grid or other seperate power sources which makes them somehow unpractical.

### SUMMARY OF THE INVENTION

It is the characteristic of this invention that the electrical power source are solar cells and that these solar cells are tightly integrated into the reloading apparatus, into the battery or battery pack itself.

To relaod the batteries one has only to put the device or battery into daylight.

For a fuller understanding of the nature of the invention, reference should be made to the following detailed description of the preferred embodiments of the invention, considered together with the accompanying drawings.

### BRIEF DESCRIPTION OF THE DRAWINGS

FIG. 1 is a schematic view of a battery with integrated solar cells.

FIG. 2 shows a loader-box with integrated solar cells.

### DESCRIPTION OF THE PREFERRED EMBODIMENTS

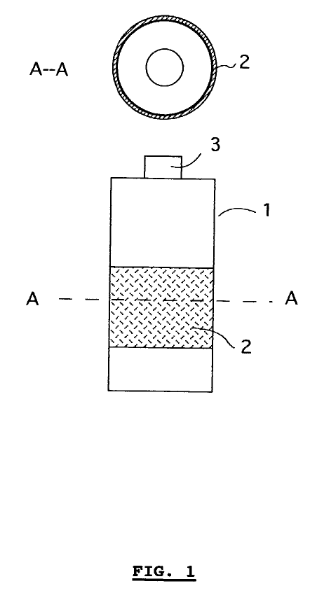

The following is a description of a first embodiment of the invention and refers to FIG. 1. The device is a battery with a cylindrical casing 1. One or several solar cells 2 are integrated into this casing at the outer surface. The cells are arranged circumferencially so that light can reach them in any position. The cells are electrically connected to the electrodes of the battery. 3 shows one of the electrodes. A voltage limiter as means for voltage limiting (e.g. a zener diode in parallel to the solar cells) may be integrated to prevent overloading. The solar cells are chosen or arranged (i.e. series or parallel connection) to produce a voltage (i.e. a little bit more than the loading voltage) sufficient for loading the reloadable battery. To prevent unloading in the dark a diode may be connected in series with the solar cell as means against unloading via the solar cells. A more sophisticated battery may be equipped with load-controlling means, i.e. a loading controller which controls the loading process.

At square battery cells just one surface may be equipped with the solar cells.

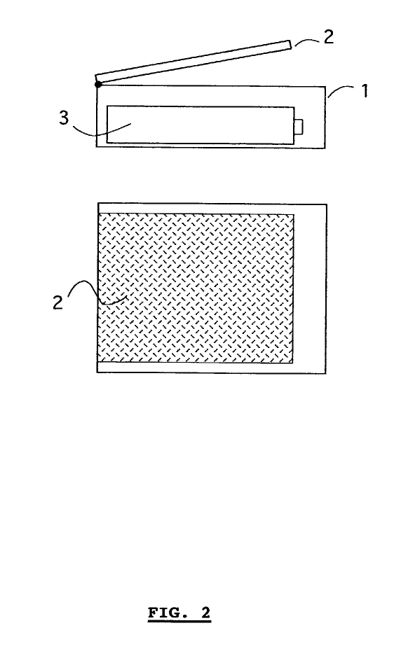

FIG. 2 shows a battery reloader with integrated solar cells. The solar cells are integrated into the lid 2 of the housing 1. A battery is shown with 3.

While the present invention has been described in connection with particular embodiments thereof, it will be understood by those skilled in the art that many changes and modifications may be made without departing from the true spirit and scope of the present invention. This changes concern variations of housing shapes and locations of the cells. Therefore, it is intended by the appended claims to cover all such changes and modifications which come within the true spirit and scope of this invention.

What is claimed is:

1. In a reloadable battery, the improvement
of a battery casing which comprises solar cells arranged such that light can reach them when the battery is exposed to light, wherein the solar cells are electrically connected to the electrodes of the battery.

2.) Device according to claim 1,
further comprising means for voltage limiting.

3.) Device according to claim 1,
further comprising means against unloading via the solar cells.

4.) Device according to claim 1,
further comprising load-controlling means.

5.) In a battery loader, the improvement of
solar cells being integrated into the housing such that light can reach them.
